(19) United States
(12) Patent Application Publication
(10) Pub. No.: US 2008/0104117 A1
(43) Pub. Date: May 1, 2008

(54) Radio-Networked Welder System

(75) Inventors: John K. Stevens, Stratham, NH (US); Paul Waterhouse, Selkirk (CA); M. Jason August, Toronto (CA)

Correspondence Address: Marina Larson & Associates, LLC, re:VAI, P.O. Box 4928, Dillon, CO, 80435-4928, US

(73) Assignee: VISIBLE ASSETS, INC., Mississauga (CA)

(21) Appl. No.: 11/875,430

(22) Filed: Oct. 19, 2007

Related U.S. Application Data
(60) Provisional application No. 60/862,176, filed on Oct. 19, 2006.
(60) Provisional application No. 60/867,578, filed on Nov. 28, 2006.

(51) Int. Cl. G06F 7/00; G06F 17/30

(52) U.S. Cl. 707/104.1; 707/E17.001

(57) ABSTRACT

Radio-tagged components are used a welding operation to form a welded product. Pedigree/quality control is monitored by tagging welding wire with a first radio transceiver storing information about the wire; providing a second radio transceiver at the welding apparatus, providing a third radio transceiver associated with the at the human operator, logging information about the wire, the operator, and the characteristics of the weld, and maintaining the logged information at a location remote from the welder along with a time stamp and a means of authenticating the maintained log. The first, second and third transceivers operate at a frequency below 1 megahertz, preferably below 300 KHz. A similar radio tag with product pedigree information may also be affixed to the welded product.

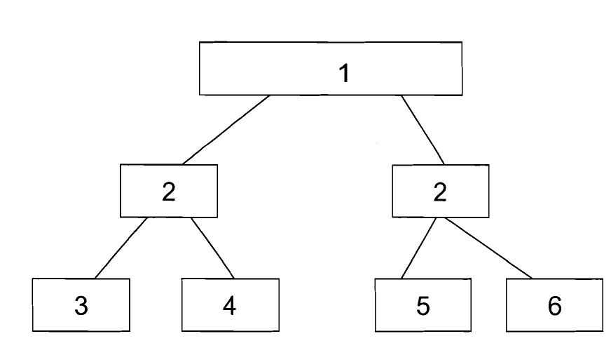

### STATEMENT OF RELATED APPLICATIONS

This application claims the benefit of U.S. Provisional Applications Nos. 60/892,176, filed Oct. 19, 2006, and 60/867,578, filed Nov. 28, 2006, both of which are incorporated herein by reference.

### BACKGROUND OF THE INVENTION

The present invention relates to the use of a long-wavelength, inductive, ultra low power two-way transceiver radio tag communications protocol in the highly challenging environment associated with welding and steel fabrication for the management of inventory, use of welding machinery, quality control management and product pedigree.

Radio-frequency identification (RFID) tags are known, together with their use in enterprise supply chain management, improving the efficiency of inventory tracking and management. As knowledge of these uses has spread, numerous proposals have been made to use RFID tags for other purposes as well. In many cases, however, these proposals are part nothing but suggestions that have not achieved practical implementation. For example, U.S. Pat. No. 6,510,984 discloses coded and electronically tagged welding wire and suggests that such coding can be done through the use of RFID tags, bar code labels or tabs, ROM, IC (integrated circuit) plates or boards, Touch Memory buttons, and the like. Nothing in this patent, however, addresses issues concerning the reliability of conventional RFID tags in the environment found around welding operations.

Welding operations involve the use of high current flow, as well as large masses of metal. Thus, there are inherently variable electromagnetic fields present in areas where welding occurs. RFID tags depend on the ability of an antenna in the card to receive the magnetic field signal from a reader and the ability to send an electromagnetic signal back to the reader. While the use of a strong enough signal can overcome background environmental interference, the use of such a strong signal requires a prohibitive amount of power to permit continuous use in a battery powered tag. Furthermore, intermittent transmission is not adequate as the signals must be reliably transmitted and received a sufficient percentage of the time to consistently provide meaningful information. If an RFID tag is moving through an environment with areas of greater and lesser background electromagnetic radiation (for example due to the proximity of welding machines or due to the operating state of welding machines) it any provide correct information at some times, and unreadable information at others. Thus, while the concept of using RFID tags in association with welding machines is good in theory it is not workable in practice. See also US Patent Publications 2007-0024463 and 2007-0205861 and U.S. Pat. No. 6,267,291 which are incorporated herein by reference.

The present invention provides the benefits of the idea of using RFID tags in the type of extreme environment found in and around welding machines through the use of an alternative communications protocol, which is actually shown to work with sufficient reliability to achieve the desired goals.

### SUMMARY OF THE INVENTION

The present invention provides radio-tagged components used in a welding operation and a method for use in welding with a human operator and a welding apparatus to form a welded product. The method comprises the steps of:

(a) tagging welding wire with a first radio transceiver storing information about the wire;

(b) providing a second radio transceiver at the welding apparatus,

(c) providing a third radio transceiver associated with the at the human operator,

(d) logging the information about the wire, the operator, and the characteristics of the weld, and

(e) maintaining the logged information at a location remote from the welder along with a time stamp and a means of authenticating the maintained log,

wherein the first, second and third transceivers operate at a frequency below 1 megahertz, preferably below 300 KHz. A similar radio tag with product pedigree information may also be affixed to the welded product.

### BRIEF DESCRIPTION OF THE FIGURE

The Figure shows a schematic representation of a networked welder system.

### DETAILED DESCRIPTION OF THE INVENTION

The present application relates to the use of radio tags that are tuned to operate as long wavelength inductive tags. These tags uses long wavelengths below 1 megahertz, for example between 10 KHz to 500 KHz (Low frequency or Ultra Low Frequency ULF, as defined by Part 15 rules of the FCC) which are suitable for inductive tags, preferably below 300 KHz. As noted above, since the wavelength is so long at these low frequencies over 99% of the radiated energy is magnetic as opposed to a radiated electric field.

In order to establish the actual efficacy of the long wavelength inductive two-way radio tags in the extreme environment associated with welding operations, RUBEE™ tags from Visible Assets, Inc. were used in field testing. The RUBEE protocol uses a full duplex 131 KHz data carrier with amplitude modulated data communication. The long wavelength produces little, if any, energy in the form of an electrical field (E), and most of the radiated energy (99.99%) is in the form of a magnetic field (H). The RUBEE tags typically need a minimum signal of 0.1 milligauss to a maximum of 200 milligauss for reliable communication. The strongest field near or on top of a base station and high performance antenna for communication with a RUBEE tag can be about 1000 milligauss, however most standard antennas are in the 100-800 milligauss range. To provide some context for this value, the earth's magnetic field is 300-6000 milligauss.

In the field testing the following materials were used:

HP1217 1200 milligauss calibrated test antenna.

Blaster 10 Base Station

4 V7D calibrated t-tags (1>milligauss sensitivity)

Finder V7.14

P-HHM 00122 Handheld

Tests were carried out in five different locations in a heavy industrial site that made railroad cars. The five locations/test conditions used in the study were:

1. control data: a floor area located in the MIG welding fabrication building, and 10′ (10 feet) removed from active MIG welding equipment. Four standard 7D RUBEE tags were placed 1 foot from the antenna. 966 reads (240) per tag were collected as a baseline.

2. storage area data: a storage inventory warehouse area. Tags were placed on MIG wire coils and fully loaded skids and read from a distance. The inventory area was 20 feet removed from active MIG welding equipment and the tags were about 3 feet from the antenna.

3. Cable 1 data. A high current power cable was placed near the standard antenna in an operational MIG welding fabrication area. The cable fed power to a standard Series 75 Miller Wire Feed System with Dimension Series power supply. An Axcess MIG System wire feeder and power cables were located adjacent to the Series 75 wire feeder.

4. Cable 2 data: similar to the Cable 1 data except that the power cable was located near the radio tags rather than the antenna. The power cables in this case were fed to a Miller Gouger welder.

5. TIG Open Arc data—tags and antenna were placed near an active Miller TIG welder.

Finder data logs were collected and analyzed for each of these conditions, and four basic statistics were evaluated. These statistics were (1) a basic signal strength histogram which may identify sources of noise; (2) a scatter plot of time versus signal strength; (3) a tabular display of tag number versus various numerical statistics relevant to performance, and (4) a table of tag numbers versus the percentage of successful reads. In most cases, 10% successful read in a harsh environment is considered successful and shows that most tags will be read several times as they pass by a reader.

The control data obtained in this test showed now errors, and strong signal. In the inventory storage area, the signal strength was reduced, consistent with the larger distance from the antenna. Few errors were observed and the average read rate was about 50%.

The two cable tests were carried out to check a worst case scenario. The cables will radiate a strong inductive pulse. It was determined that when the noise source (cable 1) was close to the antenna, the signal may be blocked. However, reads are acceptable when the unit is not active. When the antenna is moved a few feet away from the cable and it is the tags that are close to the cable (Cable 2), reads are at an acceptable rate of nearly 90%. Thus, artificial noise generated by high current in cables does not substantially reduce the low-wavelength tag as long as it is not position directly between the tag and the antenna or immediately adjacent the antenna. Table 1 summarizes the signal strength and read rate results for the tests performed in the first four environments.

TABLE 1

| Environment | Avg Signal Amplitude | Avg % Tags Found |
|---|---|---|
| Control | 2447 | 100 |
| Storage | 426 | 62.8 |
| Cable 1 | 1739 | |
| Cable 2 | 3206 | 89.8 |

The fifth environment tested was adjacent to the open arc welder itself. There were blocks of time when performance deteriorated but on average the read rate was an acceptable 30 to 60%.

These tests established that the long wavelength tags such as RUBEE tags can be used in even the worst case conditions with an active arc welder only a few feet away or a power cable near for example 8 to 10 inches away from the antenna. This allows the implementation of radio tagging procedures in the industrial industry for parts and product identification, quality control of welds and general product pedigree.

Thus, in a first aspect of the invention, there are provided product and product components labeled with long wavelength radio tags. Product components include both metal components to be welded together to make a final product and welding wire and spools. The radio tag can be used to store information concerning the usage of the wire on the spool for inventory control, or the provenance of the wire on the spool for transfer to a tag on a welded product in which the wire is used as part of the quality control/pedigree information for that product.

The invention further provides for welding machinery such as wire feeders and welding machines that have long wavelength radio tags associated therewith. Such tags can store information concerning the identity and usage of the device for transfer to pedigree tags on products, and in the case of automated welding systems can also provide positional information on the device within a facility. The tag can be also used to store apparatus check in/out information to associate particular users with the apparatus.

Because of the ability of the long wavelength radio tags to function in the environment found around welding operations, tags of this type can be used in creating visibility networks in welding industry application. A “Visibility Network” provides tracking data, but also provides real-time, interactive asset status. A Visibility Network is a real-time on-demand, local area network, so real-time sensor alerts are possible (e.g. temperature, jog, flow), real-time asset location (e. g. asset is on the shelf now or in use in the operating room), real-time asset status (e.g. the box is unopened), and real-time pair-wise linking (the patient and the blood type match) is possible. A Visibility Network may also be interactive in that it can operate effectors (e.g. open locks; flash LED's for pick and place; or display information on an LCD display). Thus, asset tracking provides history (pedigree where asset has been). Visibility Networks provide asset tracking, but also provide real-time, interactive, local area network status of an asset (pedigree and where it is now).

Networked Welder Visibility Network in accordance with the invention is designed to provide any combination or all of the following functions:
1. manage consumable on-site inventory (wire, spools) to provide just-in-time events and point of use data;
2. manage the use of welding machinery, by providing the ID of a welder, wire type and feed rates.
3. create an active visibility network that provides critical information to persons on the welding shop floor. This information can be provided in a language and information density/sophistication compatible with the person making the query where the person is identified to the network.
4. check in/check out functions for tools, tips and wire.
5. provide legal audit trails under 21 CFR art 11 as well as Sorbanes-Oxley (SOX) logs linked to use of a product
6. provide pedigree and quality control data permanently attached to the produced product. This can give an unchallengeable portable pedigree with independent Part 11 audit trail for the product.
7. identification of human resources. The person who actually makes a weld can be identified in the network through a radio tag and read by a tagged welder for transfer of the information to a tagged product.

The ability to provide this type of network in the context of welded products is of particular significance because of the potentially life or death importance of the quality of the weld. To provide a full pedigree for a product, it is necessary to have quality control data on the individual component parts and also on the weld itself. In the latter case, information of relevance can include the wire used, the welder who did the job, the time required for the weld and the like.

The Figure shows a schematic representation of a network in accordance with the invention. The network has a server 1 such as a Visible Assets DOT TAG™ server in communication with one or more readers 2, such as Visible Assets SIDEWINDER™ readers. The server maintains data and may hold application code for the creation of Part 11 or SOX logs. These may be stored internally as well as written to an audit trail CD or other storage means. Preferably this includes authenticated time stamps, such as those obtained through a WORM drive. The readers 2 are in communication with radio tags placed on the network assets 3-6. of course it will be appreciated that the number of assets in this network is for convenience of depiction and is not a limit on the number of radio tags that may be included within the network.

Network assets 3-6 may include wire coils, in which the data stored on the tag suitably includes information about the wire type and size, manufacturer, manufacturing date, serial numbers, certification numbers as well as other information that may be useful for establishing pedigree or inventory control. Tags of this type may be read in a storage area, when a wire spool is on a fork lift or in use.

Network assets 3-6 also suitably include a wire feeder, a welding machine, and human operators. The reader 2 may be associated directly with the wire feeder and interface with the controller of the wire feeder to obtain information about the amount of wire used. In this position, it can also obtain information from human operators with a radio ID tag, and nearby welders.

These parts in combination create a visibility network useful in a method in accordance with the invention for use in welding with a human operator and a welding apparatus. This method comprises the steps of:

(a) tagging welding wire with a first radio transceiver storing information about the wire;

(b) providing a second radio transceiver at the welding apparatus,

(c) providing a third radio transceiver associated with the at the human operator,

(d) logging the information about the wire, the operator, and the characteristics of the weld, and

(e) maintaining the logged information at a location remote from the welder along with a time stamp and a means of authenticating the maintained log,

wherein the first, second and third transceivers operate at a frequency below 1 megahertz, preferably below 300 KHz.

In this network, welding wire having associated therewith a radio transceiver that operates at a frequency below 1 megahertz, is used. As used herein, the term “associated with” means affixed directly to the wire, or to a carrier such as a spool. The transceiver stores information concerning the type and provenance of the welding wire. In preferred embodiment, the transceiver associated with the welding wire operates at a frequency below 300 KHz, preferably at a frequency of 133 KHz.

What is claimed is:

1. A method for use in welding with a human operator and a welding apparatus to form a welded product, said method comprising the steps of:
(a) tagging welding wire with a first radio transceiver storing information about the wire;
(b) providing a second radio transceiver at the welding apparatus,
(c) providing a third radio transceiver associated with the at the human operator,
(d) logging the information about the wire, the operator, and the characteristics of the weld, and
(e) maintaining the logged information at a location remote from the welder along with a time stamp and a means of authenticating the maintained log,
wherein the first, second and third transceivers operate at a frequency below 1 megahertz.

2. The method of claim 1, wherein the first, second and third transceivers operate at a frequency below 300 KHz.

3. The method of claim 1, wherein the first, second and third transceivers operate at a frequency of 133 KHz.

4. The method of claim 1, further comprising the step of providing a fourth radio transceiver on the welded product, said fourth radio transceiver have stored information concerning the pedigree of the welded product, wherein the fourth transceiver operates at a frequency below 1 megahertz.

5. The method of claim 4, wherein the first, second, third and fourth transceivers operate at a frequency below 300 KHz.

6. The method of claim 4, wherein the first, second, third and fourth transceivers operate at a frequency of 133 KHz.

7. Welding wire having associated therewith a radio transceiver that operates at a frequency below 1 megahertz, said transceiver storing information concerning the type and provenance of the welding wire.

8. Welding wire according to claim 7, wherein the transceiver operates at a frequency below 300 KHz.

9. Welding wire according to claim 7, wherein the transceiver operates at a frequency of 133 KHz.

10. Welding equipment having associated therewith a radio transceiver that operates at a frequency below 1 megahertz, said transceiver storing information concerning the identification of the equipment.

11. Welding equipment according to claim 10, wherein the transceiver operates at a frequency below 300 KHz.

12. Welding equipment according to claim 10, wherein the transceiver operates at a frequency of 133 KHz.

13. Welding equipment according to claim 10, wherein the welding equipment is a wire feeder.

14. Welding equipment according to claim 13, wherein the transceiver has the ability to read information for a second transceiver associated with welding wire.

15. Welding equipment according to claim 14, wherein the transceiver operates at a frequency below 300 KHz.

16. Welding equipment according to claim 14, wherein the transceiver operates at a frequency of 133 KHz.

17. Welding equipment according to claim 10, wherein equipment is a welder.

18. A welded product comprising at least two metal components joined together by a weld and a radio transceiver that operates at a frequency below 1 megahertz affixed to one of the components, said transceiver storing information concerning the formation of the weld.

19. The welded product according to claim 18, wherein the transceiver operates at a frequency below 300 KHz.

20. The welded product according to claim 18, wherein the transceiver operates at a frequency of 133 KHz.

21. The welded product according to claim 18, wherein the information concerning the formation of the weld includes one or more of the identity of the welding wire used, the specific welding apparatus used, the human operator of the welding apparatus, and the date the weld was formed.

22. The welded product according to claim 21, wherein the transceiver operates at a frequency below 300 KHz.

23. The welded product according to claim 21, wherein the transceiver operates at a frequency of 133KHz.
